(19) United States
(12) Patent Application Publication
(10) Pub. No.: US 2023/0123446 A1
(43) Pub. Date: Apr. 20, 2023

(54) PREVENTING MISDIRECTED PASSWORD ENTRY

(71) Applicant: Citrix Systems, Inc., Ft. Lauderdale, FL (US)

(72) Inventor: Manbinder Pal Singh, Coral Springs, FL (US)

(73) Assignee: Citrix Systems, Inc., Ft. Lauderdale, FL (US)

(21) Appl. No.: 17/501,579

(22) Filed: Oct. 14, 2021

(51) Int. Cl. G06F 21/62

(52) U.S. Cl. CPC G06F 21/6245

(57) ABSTRACT

A computer system is provided. The computer system includes a memory and at least one processor coupled to the memory and configured to detect entry of data into a username entry field of a login form served to a web browser from a website. The at least one processor is further configured to detect a paste operation associated with the login form. The at least one processor is further configured to identify a focus for the paste operation. The at least one processor is further configured to perform a security action in response to the focus not being directed to a field other than a password entry field of the login form. Th security action may include blocking the paste operation, providing a warning, and/or obtaining confirmation for the paste operation.

### BACKGROUND

Password security is an issue of great importance, as attacks on computer systems and the users of those systems continue to increase due to compromised passwords. There are many ways in which passwords can be leaked or compromised through inadvertent user actions. Simply relying on user vigilance, which is subject to lapse, does not provide reliable or sufficient security.

### SUMMARY

In at least one example, a computer system is provided. The computer system includes a memory; and at least one processor coupled to the memory and configured to: detect entry of a username into a username entry field of a login form; detect a paste operation associated with the login form; identify a focus for the paste operation; and perform a security action in response to the focus being directed to a field other than a password entry field of the login form.

At least some examples of the computer system can include one or more of the following features. The security action comprises blocking the paste operation. The security action comprises providing a warning and obtaining confirmation for the paste operation. The at least one processor is further configured to implement an event handler to detect the entry of the username into the username entry field, to detect the paste operation, and to identify the focus for the paste operation. The login form is served to a web browser from a website and the at least one processor is further configured to detect the entry of the username into the username entry field by the web browser based on settings of a cookie maintained by the web browser. The field other than the password entry field is the username entry field or an address bar. The paste operation is associated with a mouse operation or with one or more keystrokes.

In at least one example, a method for password protection is provided. The method includes detecting, by a computer system, entry of a username into a username entry field of a login form; detecting, by the computer system, a paste operation associated with the login form; identifying, by the computer system, a focus for the paste operation; and performing, by the computer system, a security action in response to the focus being directed to a field other than a password entry field of the login form.

At least some examples of the method can include one or more of the following features. Performing the security action comprises blocking the paste operation. Performing the security action comprises providing a warning and obtaining confirmation for the paste operation. The act of implementing an event handler to detect the entry of the username into the username entry field, to detect the paste operation, and to identify the focus for the paste operation. The login form is served to a web browser from a website and the method further comprises the act of detecting the entry of the username into the username entry field by the web browser based on settings of a cookie maintained by the web browser. The field other than the password entry field is the username entry field or an address bar. The paste operation is associated with a mouse operation or with one or more keystrokes.

In at least one example, a non-transitory computer readable medium storing executable sequences of instructions to provide password protection, the sequences of instructions comprising instructions to: detect entry of a username into a username entry field of a login form; detect a paste operation associated with the login form; identify a focus for the paste operation; and perform a security action in response to the focus being directed to a field other than a password entry field of the login form.

At least some examples of the non-transitory computer readable medium can include one or more of the following features. The security action comprises blocking the paste operation. The security action comprises providing a warning and obtaining confirmation for the paste operation. Instructions to implement an event handler to detect the entry of the username into the username entry field, to detect the paste operation, and to identify the focus for the paste operation. The login form is served to a web browser from a website and the sequences of instructions further include instructions to detect the entry of the username into the username entry field by the web browser based on settings of a cookie maintained by the web browser. The field other than the password entry field is the username entry field or an address bar. The paste operation is associated with a mouse operation or with one or more keystrokes.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of an implementation of a system for providing protection against misdirected password entry, in accordance with an example of the present disclosure.

FIG. 2 is a block diagram of the password protection system, in accordance with an example of the present disclosure.

FIG. 3 is a flow diagram of a process for password protection, in accordance with an example of the present disclosure.

FIG. 4 is another flow diagram of a process for password protection, in accordance with an example of the present disclosure.

FIG. 5 is a block diagram of a computing platform configured to perform a process for password protection, in accordance with an example of the present disclosure.

### DETAILED DESCRIPTION

As noted previously, password security is an issue of great importance, as attacks on computer systems and the users of those systems continue to increase due to compromised passwords. One way in which passwords can be leaked and compromised is through the inadvertent entry of a password into the wrong field on a login form or browser page. For example, a user may accidentally paste their password into the address bar or the username entry field of the login form rather than the password entry field. Such mistaken password entry can result in transmission of the password, in plain text or unencrypted form, to any number of unintended destinations from which the password may fall into the hands of bad actors.

Given the fact that users need to maintain a growing number of passwords, of increasing complexity, to meet the ever more demanding security requirements that are being imposed on them, many users resort to storing a list of their passwords in a text document on their computer. Although this practice is strongly discouraged, due to potential for theft of the document, it does nevertheless occur. In some examples, the user copies the password from the text document and then shifts focus back to the login page to perform a paste operation. During this process it is relatively easy to paste the password into the wrong field, particularly if the user is distracted by other workplace demands. In some examples, when switching from a browser to another application and then back to the browser, the original password field focus of the browser may be changed in a manner that is not easily noticed.

If the password is pasted into the username field and the user hits enter, which is a natural impulse, the login form will be transmitted to the web page server and the username field will contain the password concatenated to the username. Many login services maintain a log file of login attempts and so the user's password will be visible and exposed to anyone analyzing the log files. Many users do not realize the impact of their mistake and do not reset their password.

If the password is pasted into the address bar, and the user hits enter, the password is transmitted to a Domain Name System (DNS) server for name resolution. Since the password is not a working domain name, the DNS servers will fail to identify it and forward the password on (in plaintext) to other DNS servers, for example using multicast DNS and Link-Local Multicast Name resolution. Thus, the password will be widely transmitted over the internet, offering many opportunities for compromise.

To address these and other problems, and as summarized above, various examples described herein are directed to systems and methods to provide protection of passwords from being compromised due to user error. In some examples, the disclosed techniques are implemented, at least in part, by a web browser plug-in or extension.

In some examples, the disclosed techniques provide password protection by detecting an attempted misdirected password entry and warning or preventing the user from taking that action. This is accomplished by identifying a web page as a login form and detecting entry of a username into the username field of the login form. If a subsequent paste operation is then detected, and the focus of the paste operation is not directed to the password field of the login form, then the user is warned of the potential mistake prior to allowing the paste to complete.

These systems and methods overcome a security problem in which even the most security-conscious user can inadvertently enter their password into the wrong field on a login page. For example, a user may be distracted by other workplace demands and inadvertently paste their password into the username field, the address bar, or other input field. The disclosed techniques detect a paste operation following a username entry, identify the focus for the paste operation, and perform an appropriate security action if the focus is not directed to the password entry field.

In some examples, the disclosed systems and methods can be applied to the protection of other confidential information that may be requested through a web page, such as social security numbers or credit card numbers, using the same techniques.

As will be understood in view of this disclosure, the systems and methods for preventing misdirected password entry provided herein have advantages over existing methods which depend on the user to paste their password with careful attention. For instance, the systems and methods described herein provide automated detection and warning of a misdirected password entry and do not rely on user vigilance, which is subject to lapse. Additionally, the disclosed techniques do not require knowledge of the user's password by the system and thus avoid the security problems inherent in maintaining such information.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

### Password Protection System

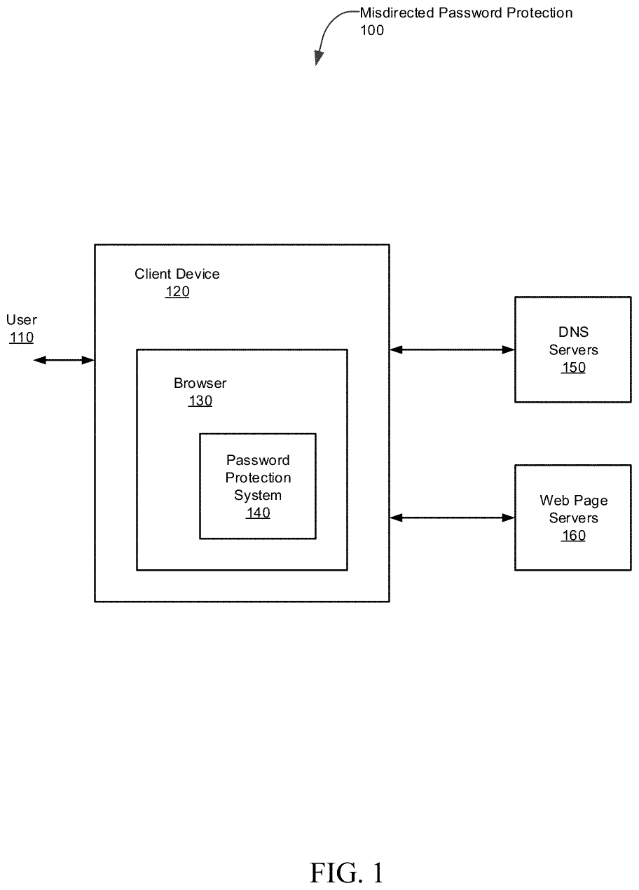

FIG. 1 is a top-level block diagram of an implementation 100 of a system for providing protection against misdirected password entry, in accordance with an example of the present disclosure. As shown in FIG. 1, the system comprises a client device 120. The client device 120 (e.g., a device such as a laptop, mobile device, workstation, etc.) is configured to execute a web browser application 130. In some examples, the web browser application may include a password protection system extension or add-in 140. The client device may communicate, for example over the Internet, with DNS servers 150 and web page servers 160.

The operation of system 140 will be explained in greater detail below, but at a high-level, the system is configured to detect that a password is about to be entered into a field other than the password entry field, which might allow the password to be compromised, and warn or prevent the user from performing the misdirected password entry.

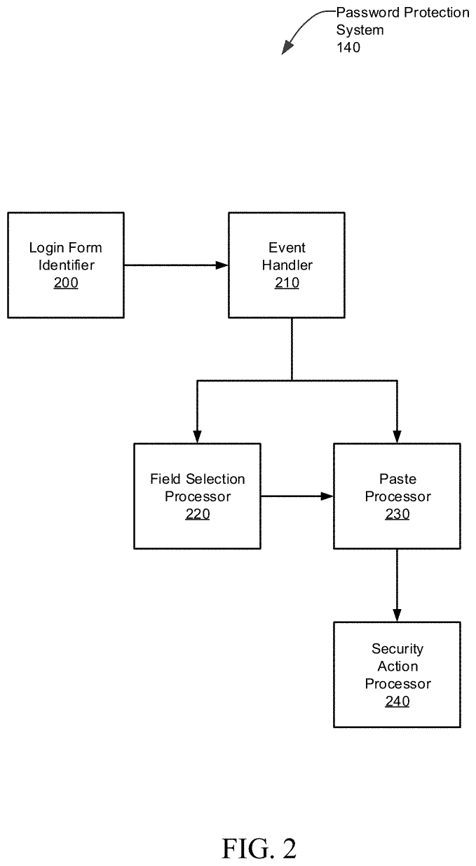

FIG. 2 is a block diagram of the password protection system 140, of FIG. 1, in accordance with an example of the present disclosure. The password protection system 140 is shown to include a login form identifier 200, an event handler 210, a field selection processor 220, a paste operation processor 230, and a security action processor 240.

The login form identifier 200 is configured to identify the web page, to which the web browser has navigated, as a login form. In some examples, the identification is based on an analysis of the document object model associated with the web page to detect fields which are labeled as “username,” “password,” or other such similar login related nomenclature. In some examples, the login form identifier 200 may be configured to perform a computer vision or machine learning analysis of the web page image. For example, login form identifier 200 may employ a neural network that has been trained to recognize images of login pages. In some examples, the login form identifier 200 may be configured to perform the identification based on detection of one or more keywords, such as “login,” that are present in the Uniform Resource Locator (URL) of the web page.

The event handler 210 is configured to trigger processing (e.g., by the field selection processor 220 and the paste operation processor 230) based on the occurrence of an event associated with the web page, such as a focus change, a keystroke, and/or a paste operation. In some examples, User Interface (UI) automation may be employed to detect user actions as an alternative to the event handler. UI automation is an application programming interface, provided by the operating system of the client device 120, of FIG. 1, which allows one application to access, identify, and manipulate the UI elements of another application.

The field selection processor 220 is configured to detect entry of a username into the username field of the login form, as will be explained in greater detail below.

The paste operation processor 230 is configured to detect that a paste operation is attempting to paste a password into a field other than the password field, as will also be explained in greater detail below.

The security action processor 240 is configured to perform a security action after detection of a misdirected password entry. The security actions may include one or more of blocking the paste operation, warning the user, and/or obtaining confirmation from the user before allowing the paste operation. Additional operations are also possible, such as logging the incident and/or notifying IT administration.

### Password Protection Process

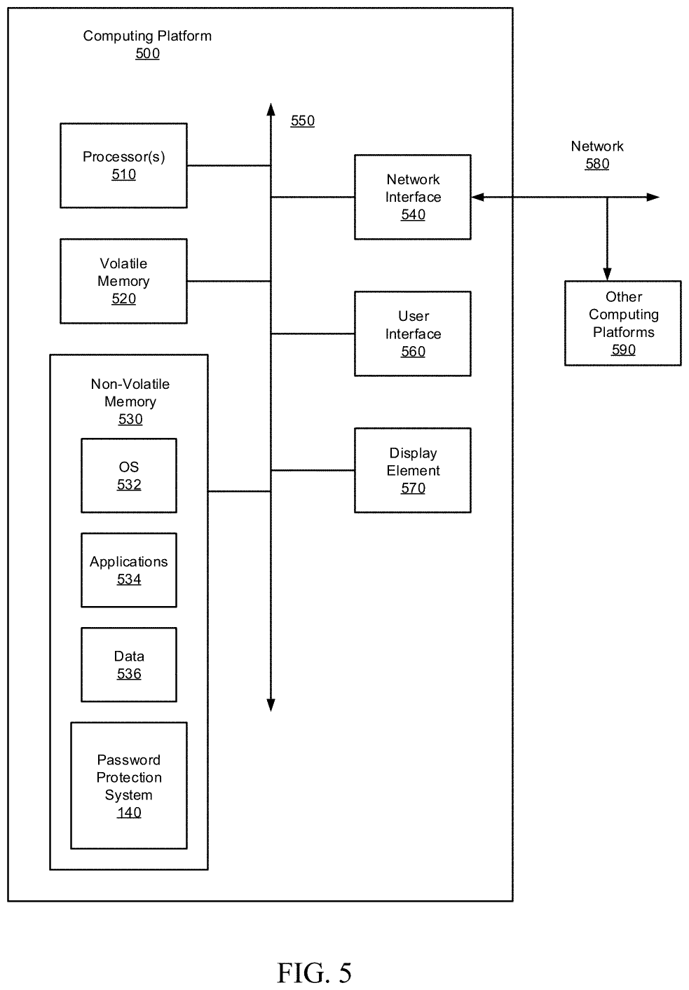

As described above, some examples of the implementation 100 of FIG. 1 are configured to perform a process for prevention of misdirected password entry. The processes may be executed on a processor of any suitable type (e.g., processor 510 of FIG. 5).

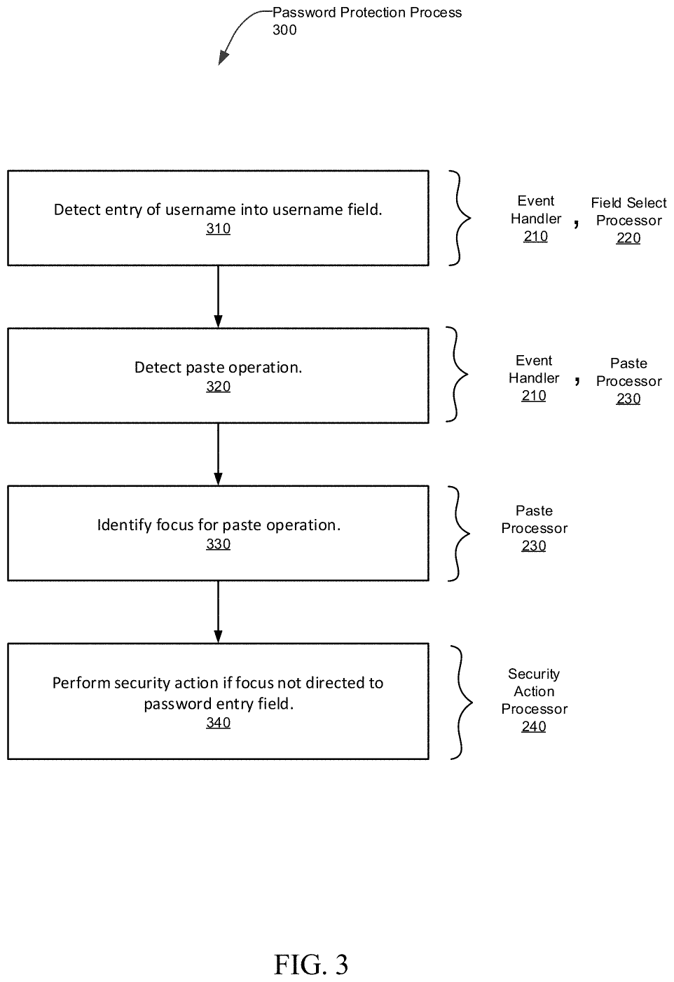

FIG. 3 is a flow diagram 300 of a process for password protection, executed by password protection system 140, of FIG. 1, or the sub-components thereof, in accordance with an example of the present disclosure.

At operation 310, entry of a username into the username field of a login form is detected. In some examples, the detection may be accomplished through the use of an event handler (or UI automation mechanism) that triggers on entry of data in the username field, whether by keystroke or paste operations. In some examples, the browser is configured to automatically enter the username, based on cookie settings maintained by the web browser, and this automated entry can also be detected based on the cookie settings or by checking that the value of the username input field is not empty or null when the page is loaded.

Next, at operation 320, a paste operation is detected subsequent to the username entry. In some examples, the detection may be accomplished through the use of an event handler (or UI automation mechanism) that triggers on entry of data in the password field, through a paste operation, which is more prone to user misdirection error than keystroke entries.

At operation 330, the focus of the paste operation on the login form is identified. The focus could be directed to any element of the login form.

At operation 340, if the focus of the paste operation is not directed to the password entry field of the login form, a security operation is performed. In some cases, the security operation may include blocking the paste operation, warning the user, and/or obtaining confirmation from the user before allowing the paste operation.

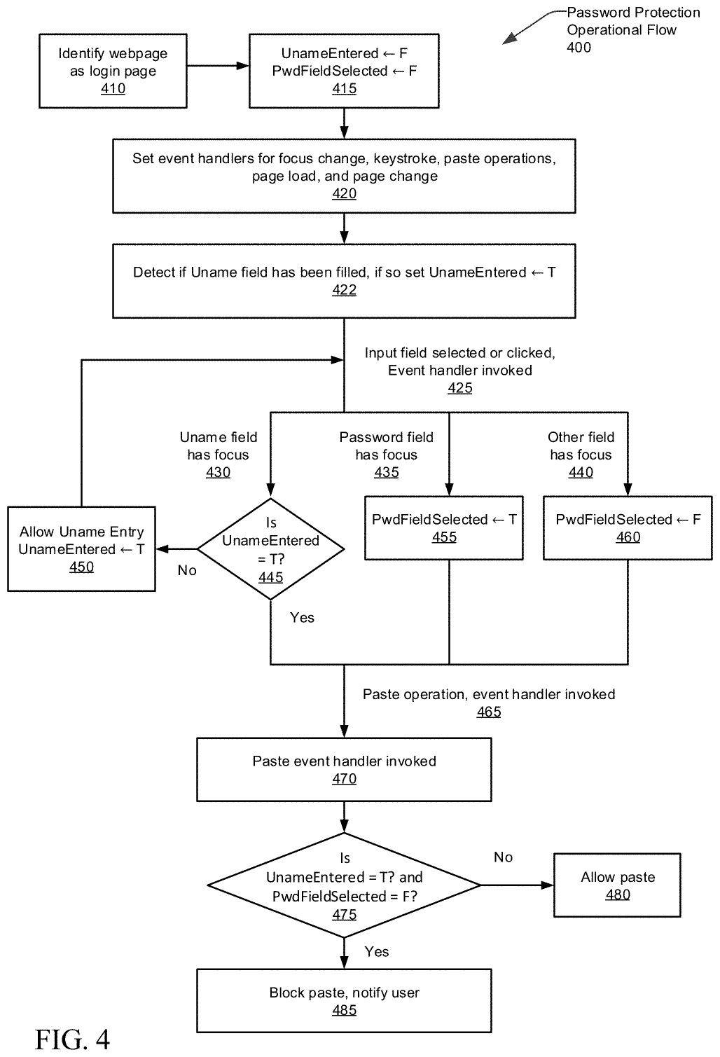

FIG. 4 is another flow diagram 400 of a process for password protection, executed by password protection system 140, of FIG. 1, or the sub-components thereof, in accordance with an example of the present disclosure.

The process 400 starts at operation 410, by identifying a web page, to which the web browser has navigated, as a login page or login form. In some cases, the identification may be based on analysis of the document object model associated with the web page to detect labeled fields such as “username” and “password,” or the like. In some cases, the identification may be based on a computer vision or machine learning analysis of the web page image, where, for example, a neural network has been trained to recognize login pages. In some cases, the identification may be based on detection of keywords, such as “login,” that are present in the URL of the web page.

Next, at operation 415, two state variables “UserNameEntered” and “PasswordFieldSelected” are initialized to FALSE.

At operation 420, event handlers are set up to trigger on any of the following events: a focus change; a keystroke; a paste operation; a page load; and a page change. In some examples, the paste operation may be associated with a mouse operation (e.g., a mouse click), or one or more keystrokes (e.g., a control-v). If the username field has already been filled in, then at operation 422, the UserNameEntered state variable is set to TRUE. This may occur, for example, if the browser is configured to automatically enter the username, or if a previous login attempt failed for any reason in which case a second login attempt may include only a password entry.

When an input field of the login form is selected or clicked 425, for example by the user that is viewing the web page, the event handler is triggered.

If the username field has received focus 430, then, at operation 445, a check is performed to determine if the username has already been entered (e.g., if UserNameEntered=TRUE). If the username has not yet been entered, then, at operation 450, entry of the username is permitted and the UserNameEntered state variable is set to TRUE. Otherwise, the process continues, as will be described below.

If, however, the password field has received focus 435, then, at operation 455, the PasswordFieldSelected state variable is set to TRUE and the process continues, as will be described below. Alternatively, if a field other than the username field or password field has received focus 440, then, at operation 460, the PasswordFieldSelected state variable is set to FALSE and the process continues.

When a paste operation is performed 465, for example by the user copying and pasting a password into the login form, the event handler is once again triggered at operation 470.

At operation 475, UserNameEntered and PasswordFieldSelected are checked. If both UsernameEntered is TRUE and PasswordFieldSelected is FALSE, then the paste operation is blocked at operation 485, and the user is notified of a potential mistake. Otherwise, at operation 480, the paste operation is allowed.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

### Computing Platform for Password Protection

FIG. 5 is a block diagram of a computing platform 500 configured to perform a process for password protection by preventing misdirected password entry, in accordance with an example of the present disclosure. In some cases, the platform 500 is the client device 120, of FIG. 1, which may be a workstation, server, laptop, mobile device, or smartphone, etc.

The computing platform or device 500 includes one or more processors 510, volatile memory 520 (e.g., random access memory (RAM)), non-volatile memory 530, one or more network or communication interfaces 540, user interface (UI) 560, display element (e.g., screen) 570, and a communications bus 550. The computing platform 500 may also be referred to as a computer or a computer system.

The non-volatile (non-transitory) memory 530 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 560 can include one or more input/output (I/O) devices (e.g., a mouse, a keyboard, a microphone, one or more speakers, one or more biometric scanners, one or more environmental sensors, and one or more accelerometers, etc.).

The display element 570, can provide a graphical user interface (GUI) and in some cases, may be a touchscreen or any other suitable display device.

The non-volatile memory 530 stores an operating system 532, one or more applications 534, and data 536. The applications may include a web browser 130 and password protection system 140, all of FIG. 1, such that, for example, computer instructions of the operating system 532 and applications 534 are executed by processor(s) 510 out of the volatile memory 520. In some examples, the volatile memory 520 can include one or more types of RAM and/or a cache memory that can offer a faster response time than a main memory. Data can be entered through the user interface 560. Various elements of the computer 500 can communicate via the communications bus 550.

The illustrated computing platform 500 is shown merely as an example client device or server and can be implemented by any computing or processing environment with any type of machine or set of machines that can have suitable hardware and/or software capable of operating as described herein.

The processor(s) 510 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 510 can be analog, digital, or mixed. In some examples, the processor 510 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 540 can include one or more interfaces to enable the computing platform 500 to access a computer network 580 such as a Local Area Network (LAN), a Wide Area Network (WAN), a Personal Area Network (PAN), or the Internet through a variety of wired and/or wireless connections, including cellular connections. In some examples, the network 580 may allow for communication with other computing platforms 590, to enable distributed computing.

In described examples, the computing platform 500 can execute an application on behalf of a user of the client device. For example, the computing platform 500 can execute one or more virtual machines managed by a hypervisor. Each virtual machine can provide an execution session within which applications execute on behalf of a user or a client device, such as a hosted desktop session. The computing platform 500 can also execute a terminal services session to provide a hosted desktop environment. The computing platform 500 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory; and
at least one processor coupled to the memory and configured to:
detect entry of a username into a username entry field of a login form;
detect a paste operation associated with the login form;
identify a focus for the paste operation; and
perform a security action in response to the focus being directed to a field other than a password entry field of the login form.

2. The computer system of claim 1, wherein the security action comprises blocking the paste operation.

3. The computer system of claim 1, wherein the security action comprises providing a warning and obtaining confirmation for the paste operation.

4. The computer system of claim 1, wherein the at least one processor is further configured to implement an event handler to detect the entry of the username into the username entry field, to detect the paste operation, and to identify the focus for the paste operation.

5. The computer system of claim 1, wherein the login form is served to a web browser from a website and the at least one processor is further configured to detect the entry of the username into the username entry field by the web browser based on settings of a cookie maintained by the web browser.

6. The computer system of claim 1, wherein the field other than the password entry field is the username entry field or an address bar.

7. The computer system of claim 1, wherein the paste operation is associated with a mouse operation or with one or more keystrokes.

8. A method for password protection comprising:
detecting, by a computer system, entry of a username into a username entry field of a login form;
detecting, by the computer system, a paste operation associated with the login form;
identifying, by the computer system, a focus for the paste operation; and
performing, by the computer system, a security action in response to the focus being directed to a field other than a password entry field of the login form.

9. The method of claim 8, wherein performing the security action comprises blocking the paste operation.

10. The method of claim 8, wherein performing the security action comprises providing a warning and obtaining confirmation for the paste operation.

11. The method of claim 8, further comprising implementing an event handler to detect the entry of the username into the username entry field, to detect the paste operation, and to identify the focus for the paste operation.

12. The method of claim 8, wherein the login form is served to a web browser from a website and the method further comprises detecting the entry of the username into the username entry field by the web browser based on settings of a cookie maintained by the web browser.

13. The method of claim 8, wherein the field other than the password entry field is the username entry field or an address bar.

14. The method of claim 8, wherein the paste operation is associated with a mouse operation or with one or more keystrokes.

15. A non-transitory computer readable medium storing executable sequences of instructions to provide password protection, the sequences of instructions comprising instructions to:
detect entry of a username into a username entry field of a login form;
detect a paste operation associated with the login form;
identify a focus for the paste operation; and
perform a security action in response to the focus being directed to a field other than a password entry field of the login form.

16. The computer readable medium of claim 15, wherein the security action comprises blocking the paste operation.

17. The computer readable medium of claim 15, wherein the security action comprises providing a warning and obtaining confirmation for the paste operation.

18. The computer readable medium of claim 15, wherein the sequences of instructions further include instructions to implement an event handler to detect the entry of the username into the username entry field, to detect the paste operation, and to identify the focus for the paste operation.

19. The computer readable medium of claim 15, wherein the login form is served to a web browser from a website and the sequences of instructions further include instructions to detect the entry of the username into the username entry field by the web browser based on settings of a cookie maintained by the web browser.

20. The computer readable medium of claim 15, wherein the field other than the password entry field is the username entry field or an address bar.

21. The computer readable medium of claim 15, wherein the paste operation is associated with a mouse operation or with one or more keystrokes.
